(19) United States
(12) Patent Application Publication
(10) Pub. No.: US 2009/0240620 A1
(43) Pub. Date: Sep. 24, 2009

(54) SECURE PAYMENT SYSTEM

(75) Inventors: Jeff P. Kendrick, Salt Lake City, UT (US); Frank Anthony Allen, St. George, UT (US); Paul Harold Anderson, North Salt Lake, UT (US); Wayne William Peck, American Fork, UT (US)

Correspondence Address: Workman Nydegger;1000 Eagle Gate Tower, 60 East South Temple, Salt Lake City, UT, 84111, US

(73) Assignee: PROPAY USA, INC., Orem, UT (US)

(21) Appl. No.: 12/054,304

(22) Filed: Mar. 24, 2008

(51) Int. Cl. G06Q 20/00

(52) U.S. Cl. 705/39

(57) ABSTRACT

Systems and method for performing secure electronic payment transactions to allow merchants to perform payment processing such that the merchant is only required to identify a unique identifier of a customer account and not data specific to a particular payment device.

### CROSS-REFERENCE TO RELATED APPLICATIONS

Not applicable.

### BACKGROUND OF THE INVENTION

1. The Field of the Invention

The present invention relates to secure payment methods and systems. More particularly, the present invention relates to methods and systems to allow merchants to perform payment processing such that the merchant is only required to identify a unique identifier of a customer account and not data specific to a particular payment device.

2. The Relevant Technology

In purchasing transactions, there are various restrictions that are placed on merchants to ensure that sensitive customer data is protected from potential fraudulent activity. Such restrictions can increase the administrative cost of performing purchasing transactions. For example, PCI DSS is a set of standards relating to, among other things, the security of customer data (e.g., credit card numbers, identifying information, etc.) by merchants that accept credit card payments. Becoming and remaining PCI-compliant represents a significant expense to many merchants in terms of both infrastructure costs and initial/ongoing auditing costs. Estimates are in the hundreds of thousands to millions of dollars for large companies to implement these standards on their existing point of sale systems. Thus, it would be advantageous to provide merchants with systems and methods to enable merchants to perform payment processing requests without being required to be PCI-compliant. PCI compliance is only one example of a restriction that can be placed on a merchant to protect sensitive customer data and defines particular steps that a merchant must take to ensure that customer data is securely maintained. However, there may be other regulations which define other types of data that a merchant must secure or that limit the merchant's distribution of data. Thus, it would be desirable to provide merchants with systems and methods for greatly reducing costs to comply with these various regulations.

### BRIEF DESCRIPTION OF THE DRAWINGS

To further clarify the features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example of a network environment for implementing methods of the present invention.

FIG. 2 illustrates an example method of creating a customer account and unique identifier.

FIG. 3A illustrates an example of a customer account.

FIG. 3B illustrates an example of preferences.

FIG. 4 illustrates an example method of processing a payment processing request.

FIG. 5 illustrates an example of a payment processing request.

FIG. 6 illustrates an example of a payment authorization request.

### DETAILED DESCRIPTION

The present invention relates to systems and methods for allowing merchants to makes secure payment processing requests while not being subject to restriction presented by various purchase transaction regulations, such as, but not limited to PCI-compliant. The following description will use PCI compliance as one example of a regulation imposed upon merchants to protect sensitive customer data. However, PCI compliance is simply one example of a type of regulation that presents additional cost to merchants, which would be desirable to overcome while still upholding the intent of the regulation. Advantageously, the present invention can eliminate the need for the merchant to store sensitive payment information (such as credit card and checking account information) as well as the cost to comply with PCI regulations, while still allowing the merchant to perform normal financial transactions between itself and its customers. As used herein, the terms “merchant” and “biller” will be used interchangeably to indicate an entity receiving payment. The terms “customer” and “payor” will be used interchangeably to indicate an entity which is presenting a payment device for payment.

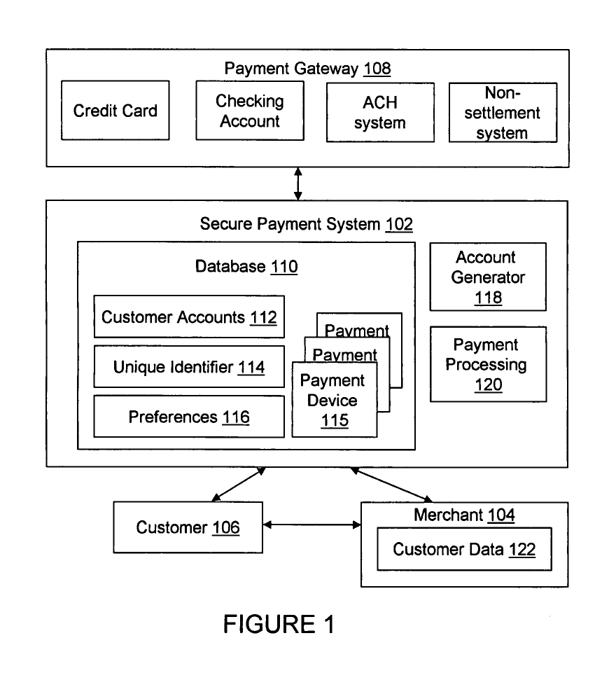

FIG. 1 shows one example of a distributed network environment 100 in which methods of the present invention may be implemented. FIG. 1 depicts environment 100 including a secure payment system 102 that can communicate with a merchant 104 and/or a customer 106. In some embodiments, secure payment system 102 will only communicate with a merchant 104; however, in other embodiments, communication with both merchant 104 and customer 106 is possible, as will become more clear from the description below. The secure payment system 102 is an intermediary between the merchant 104 and a payment gateway 108 that allows the merchant 104 to receive authorization for payment processing requests, while, at the same time, shielding the merchant from sensitive payment information so that the merchant does not have to be PCI-compliant. Furthermore, the secure payment system 102 provides mechanisms for shielding a customer from giving out sensitive payment information when the customer attempts an electronic payment transaction. Advantageously, this prevents a customer from worrying whether the merchant will fraudulently use the customer's sensitive payment information. The payment gateway 108 accesses various payment authorization systems including, but not limited to, credit card, checking account, automated clearing house (ACH) systems, proprietary non-settlement payment systems, and the like.

Secure payment system 102 can include a database 110 that stores any number of customer accounts 112. Each customer account 112 is associated with one or more unique identifiers 114, which a customer can use to identify itself to a merchant, instead of identifying sensitive payment device information, such as a credit card account number, checking account number, and the like. In this manner, the customer's sensitive payment information remains unknown to the merchant, while still allowing the merchant to perform a payment processing request.

To clarify the broadness of the terms being used herein, the term “customer” generally refers to any combination of people and entities that are authorized to use a customer account. A customer could be a single person authorized to use a unique identifier to make payment using the customer account; or the customer could be two or more persons who each are authorized to use a unique identifier to perform financial transactions using the same customer account. Alternatively, a business or organization can be associated with a unique identifier with certain people within the organization being authorized to use the unique identifier to perform financial transactions. Thus, the terms customer and customer account are intended to be broad in scope. In addition, a person or organization may have the use of more than one customer account. For example, a customer may have one customer account for personal use and a different customer account for business use. The flexibility and ease with which customers can use and define customer accounts will be apparent from the description below.

As also shown in FIG. 1, each customer account 112 can be associated with one or more payment devices 115 which allow electronic payment transactions to be performed between the customer 106 and the merchant 104. Each customer account 112 can also have rules or preferences 116. Preferences provide a large amount of flexibility in how a customer account can be used. For example, preferences can define a hierarchy of payment devices, merchant-specific preferences that apply to particular merchants, distributed payment rules/options, maximum purchase amount for electronic payment transactions, maximum number of purchases allowed, minimum balances that must be maintained on the customer account, and the like. Such flexibility allows a customer to also use a single customer account to perform both personal and business financial transactions, which can be defined by the preferences.

The secure payment system 102 includes an account generator module 118 that manages creation, definition, and/or modification of customer accounts, unique identifiers, and/or preferences. Further, the secure payment system 102 includes a payment processing module 120 that accesses the customer accounts and preferences based on a unique identifier included in a payment processing request from a merchant.

The secure payment system 102 preferably includes a distributed system of servers that include processors and storage devices for performing methods of the present invention. Since the secure payment system can be operated in a distributed manner, it will be appreciated that the singular elements of database 110, account generator module 118 and payment processing module 120 can also be plural elements.

As an initial step for performing electronic payment transactions, a customer account is generated for each customer. This can happen in a variety of ways, two examples of which will be described. However, other ways of initiating customer account generation and assigning unique identifiers to each customer account will be apparent based on the teachings herein.

Many online merchants already store a significant amount of customer data 122. In one embodiment of the invention, these merchants can transfer their sensitive and/or non-sensitive customer data to the secure payment system 102 for storage. Sensitive information refers to any information that would cause the merchant to be required to be PCI-compliant. If the merchant wishes to not be required to be PCI-compliant, after transferring sensitive information, the merchant can delete the sensitive information from the merchant's storage systems. However, a merchant may already be PCI-compliant and may desire to retain a copy of the sensitive information. In any case, it is not essential that the merchant delete sensitive information after the sensitive information is transferred to the secure payment system.

When a merchant transfers sensitive customer data, the account generator module 118 generates a customer account and a unique identifier for each of the merchant's customers. Because the secure payment system will be PCI-compliant, this transfers the responsibility of the merchant to be PCI-compliant. In one embodiment, the data in database 102 can be encrypted. The account generator module 118 can optionally identify the unique identifier for each customer back to the merchant, which the merchant can store in its customer data 122. For example, in the customer data 122, the merchant can associate the unique identifier of the customer with a user name and password for the customer. When the customer later desires to make a purchase from the merchant, such as on the merchant's website, the customer need only provide the unique identifier to the merchant.

Another way that secure payment system 102 can generate customer accounts is when a customer is attempting to perform an electronic payment transaction. For example, the customer may be online and accessing a website of the merchant. When a customer is ready to pay the merchant, such as at a payment checkout point, the merchant site 104 redirects the customer to the secure payment system site which initiates the account generator module 118. The customer supplies customer data, including sensitive customer data, to the secure payment system where the account generator module 118 creates a customer account and assigns a unique identifier to the customer account. The account generator module returns the unique identifier to the merchant 104 and/or customer 102, which the merchant can use to generate a payment processing request and/or can store for future use.

Various ways for the merchant to identify the unique identifier of the customer in order to perform an electronic payment transaction are possible. Since the present invention is not limited to any particular way of conveying the unique identifier information to the merchant, a few non-limiting examples will be described. For example, the customer can provide the unique identifier through a website of the merchant or at a point of sale device of the merchant. Alternatively, the customer does not need to provide the unique identifier and the merchant may be able to identify a unique identifier using other information provided by the customer—such as customer name, customer contact information (phone number, address, email), a customer ID specific to the merchant, and the like. The present invention is not dependent on how the merchant identifies the customer or the customer's unique identifier.

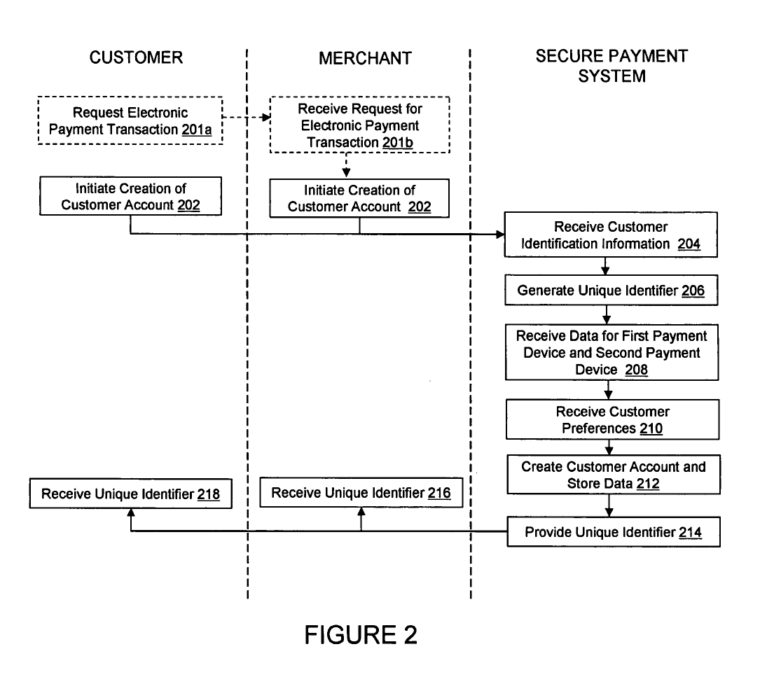

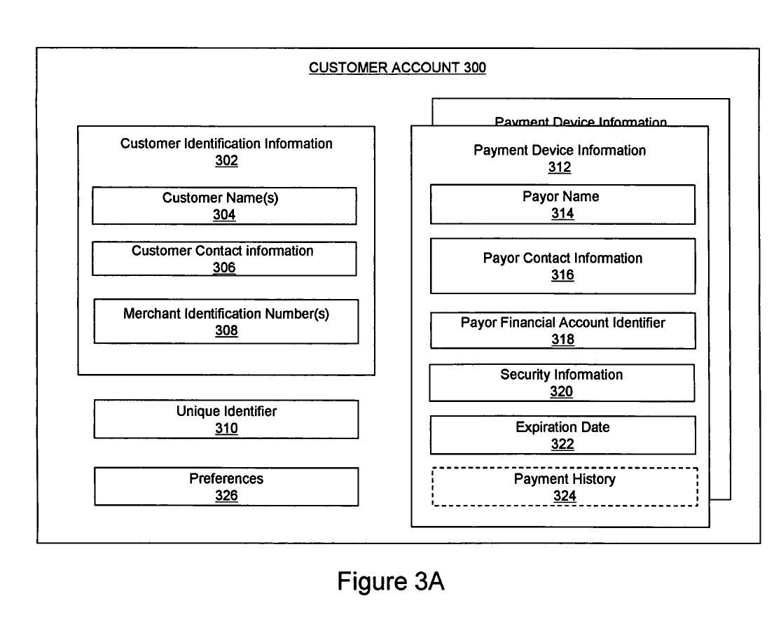

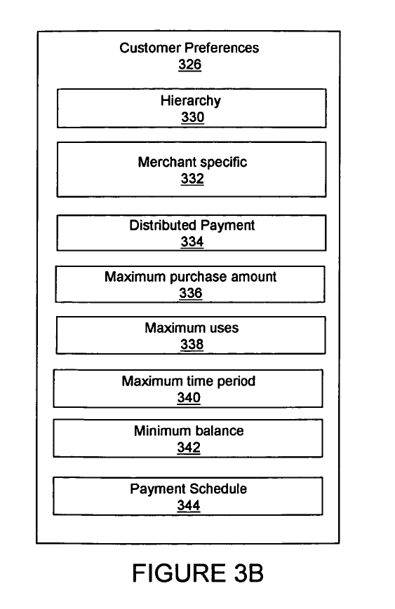

With reference to FIGS. 2 and 3 together, FIG. 2 illustrates a method 200 of generating a customer account and unique identifier in order to process electronic payment transactions so that a customer can make a payment using at least one payment device without requiring a merchant to store data specific to the payment device. As used herein, the term “payment device” is broadly defined to include any instrument which is tied to a financial account such as, but not limited to, a credit card account, checking account, or other non-settlement financial accounts.

At 202, either a merchant or a customer initiates creation of a customer account. As mentioned above, a customer account can be generated at the same time or at a different time than an electronic payment transaction is occurring. A merchant may initiate generation of a customer account at a time other than an electronic payment transaction, such as by sending a batch transfer of customer data. In this sense, the customer account can be generated independent of when a customer is attempting an electronic payment transaction. The customer can also generate a customer account even though an electronic payment transaction is not currently in progress, such as by accessing a website of the secure payment system to generate a customer account.

Or, an electronic payment transaction may be the impetus for generating a customer account. Thus, as shown in FIG. 2, optionally, a customer may, at 201a, request an electronic payment transaction, and, at 201b, the merchant can receive the request for electronic payment transaction, which can then initiate creation of the customer account. This is just one example of how generation of customer accounts can be initiated.

At 204, the secure payment system receives customer identification information from the merchant and/or customer and associates customer identification information with the customer account. FIG. 3A shows an example of a customer account 300 in greater detail. The customer identification information 302 that can be received from the merchant and/or customer can include, but is not limited to, customer name(s) 304 (which can include any number of names or persons or organizations authorized to use the customer account), customer contact information 306 (address, phone number, email, fax, social security number, etc.), and merchant identification number(s) 308 (while a particular merchant may request generation of a customer account, there can be more than one merchant that can submit payment processing requests using the same customer account).

At 206, the secure payment system generates a unique identifier associated with the customer account. The unique identifier can be any random sequence of alphanumeric characters and/or symbols. In one embodiment, the unique identifier is not based from any sensitive customer information so that it cannot be used to derive this sensitive information, especially where the unique identifier is intended to be given to the merchant without fear of exposing sensitive information. However, it is possible for the unique identifier to be at least partially based from information relating to one or more payment devices of the customer. FIG. 3 illustrates a unique identifier 310 associated with the customer account 300.

At 208, the secure payment system receives data specific to one or more payment devices. The merchant or customer can identify as many payment devices as desired. Turning to FIG. 3A, an example of payment device information 312 for a first payment device is depicted, which can include, but is not limited to, payor name 314, payor contact information 316, payor financial account identifier 318 (such as an account number, checking/debit account number, routing transit number), security information 320 (such as a PIN verification information), and expiration date 322 of the payment device.

The type of payment device information will vary depending on the payment device offered. The magnetic strip on the back of many financial cards can contain information about the account number, the name of the card owner, expiration date, a service code, and other discretionary data such as a pin verification key indicator, pin verification value, or card verification value/code. For checks, the magnetic strip at the bottom of the check can include a routing transit number, an account number, and/or a particular check number. EMV cards may proffer additional cryptographic authentication information to provide authentication of the card to the payment gateway. For example, the customer may be required to enter their PIN into the secure device, which is encrypted so that the merchant cannot access the PIN information, which is included in the payment device information 312 as security information 320 for payment processing in an encrypted format.

Other security information 320 includes biometric information, for example, where the owner of the payment device is required to perform a thumbprint scan, which information is encrypted for payment authorization. This information can be conveyed to the secure payment system in any variety of ways such as manually entering the information, swiping a payment device through a card reader to obtain information contained on a magnetic strip of the payment device, passing the payment device in front of a wireless reader, inserting the payment device into a payment device detector, and the like. Where some of the payment device information may not be readily available from the merchant or from the payment device itself, the customer may be required to supply this information, such as PIN, bio information, and the like.

Some of the data for customer identification 302 and payment device information 312 may overlap. For example, where the customer is the same as the payment device owner, the customer name and payor's name and contact information may be the same. In addition, as shown in FIG. 3, the secure payment system may optionally store payment history data 324 of payments requested and/or processed in connection with the particular customer account.

Turning back to FIG. 2, at 210, the secure payment system receives one or more preferences (shown as 326 in FIG. 3A) associated with the unique identifier including receiving an order in which the first payment device and second payment device should be used to process a payment processing request from a merchant. FIG. 3B illustrates examples of types of preferences 326 that a customer can specify, although the preferences are not limited to these particular examples. The customer can specify a hierarchy or order 330 in which any number of payment devices should be used to process a payment processing request from a merchant. The customer can input any combination of credit cards, checking accounts, and other proprietary non-settlement type of financial accounts and select an order in which these financial accounts should be used to complete electronic payment transactions. In one embodiment, a customer may solely use a proprietary non-settlement type of financial account in order to perform all of its financial transactions. The hierarchy can also be very granular, such as, by way of example, specifying a hierarchy for particular merchants so that one merchant must use particular payment devices while electronic payments for another merchant are satisfied using other payment devices. Thus, the present invention provides secure automated payment processing using a manageable hierarchy of multiple payment device options.

The customer can specify merchant-specific 332 preferences, such as specifying that payment processing requests from a particular merchant can only be processed using a particular payment device. Thus, it is possible that, even though the customer has specified a hierarchy of preferred payment devices, the secure payment system may only send an authorization request using a lower-ordered payment device if that is the only payment device that is allowed for a specific merchant.

The customer can also specify distributed payments 334 preferences. Distributing payments allows a user to complete an electronic payment transaction using different payment devices. In one embodiment, the customer can specify ratios to be applied to two or more payment devices to satisfy electronic payment transactions for the customer account or from a particular merchant. A ratio defines a percentage of a total purchase amount to be paid using the first payment device, a percentage of the total purchase amount to be paid using the second payment device, and so on. This allows a customer to have control over how much is taken from various payment devices. The customer could also specify that the ratio should be applied when the total purchase amount exceeds a particular amount. For example, the customer could specify that for purchase over $1000, 50% of the total purchase amount should be paid using a first payment device while 50% of the total purchase amount should be paid using a second payment device.

In another example, the user could specify tiers for paying electronic payment transactions. Tiers is one way of ordering payment devices for a particular payment processing request having a total purchase amount so that a first payment device is used to pay up to a first amount of the total payment amount. If the total purchase amount is above the first amount, a second payment device is used to pay an amount from the first amount up to a second amount, and so on. For example, a customer could specify that for electronic payment transactions with a particular merchant, (1) up to and including the first $100 of the total purchase amount should be paid using a first payment device; (2) if applicable, anything between the first $100 and the second $100 of the total purchase amount should be paid using a second payment device; and (3) if applicable, anything above the second $100 of the total purchase amount should be paid using a third payment device. Thus, in this example, a merchant's payment processing request could be paid using up to three different payment devices. In one embodiment, the merchant may not even be aware that a payment processing request was satisfied using two or more different payment devices. However, it is also possible for the merchant to be informed which payment devices were used to satisfy a payment processing request and in which amounts.

The customer can specify a maximum purchase amount 336 allowed for a payment processing request for every electronic payment transaction, or for payment transactions with specific merchants. The customer can specify a maximum number of uses 338 for payment processing requests allowed for the entire customer account, for a particular unique identifier (see temporary unique identifiers below), or for particular merchants. Further, the customer can specify a maximum time period 340 for which a unique identifier is valid (see temporary unique identifiers below). The customer can specify a minimum balance 342 that must be maintained on one or more payment devices associated with the customer account before a payment processing request is allowed. A payment schedule 344 could also be specified for a particular unique identifier or merchant.

Other preferences may also be specified, which will be apparent based on the teachings herein. Furthermore, the above preferences can be used in combination for more sophisticated purposes and at varying levels of granularity. For example, a customer can be so specific as to specify that a particular merchant can only use a particular unique identifier to make payment processing requests, the payment processing request can be authorized using only certain payment devices, the total purchase amount will be distributed by applying a ratio between three different payment devices, the total purchase amount must be less than a maximum purchase amount, for a limited number of uses and within a limited time period, where the customer account must maintain a minimum balance on the payment devices being used to make the payment and the payment to be made on a specific date. In this scenario, a payment processing request made from a merchant that does not satisfy one or more of these preferences would be rejected and returned back to the merchant as an error.

At 212, the secure payment system generates a customer account and associates the customer account with the unique identifier (shown as 310 in FIG. 3). The secure payment system also stores the customer account, unique identifier, customer identification information, the payment device information, and the preferences associated with the customer account.

At 214, the secure payment system provides the unique identifier to at least one of a merchant or a customer who, at 216 and 218, respectively, receive the unique identifier. As mentioned above, the customer can present the unique identifier when the customer desires to make a payment. Or, the merchant can store the unique identifier (associated with customer data maintained by the merchant), and access the unique identifier when the customer makes a payment.

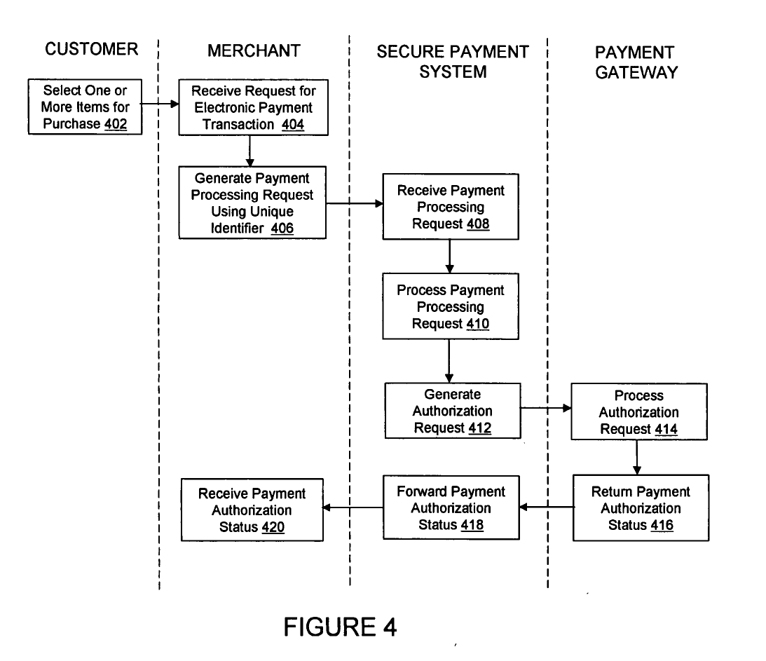

FIGS. 4 through 6 together illustrate processing an electronic payment transaction using the unique identifier. Turning to FIG. 4, the merchant generates a payment processing request using the unique identifier of the customer without requiring a merchant to store data specific to the payment device and eliminating the need for the merchant to be PCI-compliant. The payment processing request can be initiated by the customer, at 402, selecting one or more items for purchase and requesting an electronic payment transaction. At 404, the merchant receives the request for electronic payment transaction and, at 406, generates a payment processing request using the unique identifier. The merchant sends the payment processing request to the secure payment system.

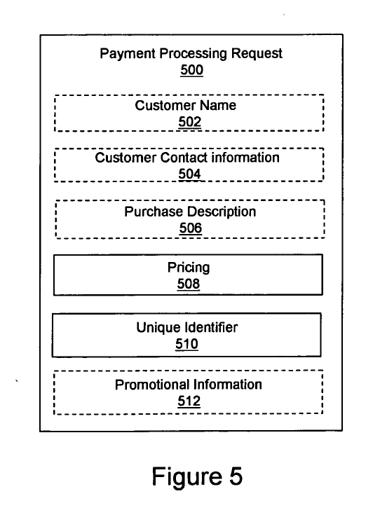

FIG. 5 illustrates one example of a payment processing request that can be generated by a merchant. As shown in FIG. 5, a payment processing request 500 can include information pertaining to the particular purchase. As such, the payment processing request 500 may include customer name 502, customer contact information 504 (such as address, telephone, email, etc.), purchase description 506 (such as items/services purchased, quantities, purchase amounts, etc.), pricing 508 (such as purchase price, tax, total purchase amount, shipping, handling, etc.), and a unique identifier 510 (i.e. a unique identifier associated with a customer account at the secure payment system). The payment processing request 500 may also include any promotional information 512 (such as discounts). In its most simple embodiment, the payment processing request 500 need only identify the pricing 508 and the unique identifier 510 in order to allow the secure payment system to complete authorization of the payment. However, certain payment gateways may require additional information and it will be appreciated that the payment processing request 500 can be modified as necessary to accommodate any required information. Certain elements of the payment processing request are depicted in dashed lines to illustrate that such information is not necessarily the focus of the present invention.

Notably, the payment processing request only needs to contain basic information of the amount of money that needs to be authorized and the unique identifier. In one embodiment, the payment processing request does not need to specify any particular payment device to initiate authorization of the electronic payment. However, it is possible for the merchant to also include payment device information where the merchant has maintained payment device information. The present invention, however, makes it so that if the merchant desires not to be PCI-compliant, the merchant can shield itself from having to store sensitive payment device information and, instead, only be required to specify the unique identifier in order to complete an electronic payment transaction.

At 408, the secure payment system receives a payment processing request from a merchant that includes the unique identifier. At 410, the secure payment system processes the payment processing request according to the one or more preferences, if specified, such that the merchant is only required to specify the unique identifier of the customer account and not the data specific to the first payment device or second payment device. Processing the payment processing request includes identifying the unique identifier in the payment processing request. The secure payment system uses the unique identifier to access the database to identify the corresponding customer account, at least one payment device to be used to satisfy the payment processing request, and any preferences. If the payment processing request does not meet one of the preferences specified in the customer account, then the secure payment system sends a status notification to the merchant. The merchant can then make any corrections (or obtain information from the customer if necessary), and resubmit the payment processing request. Or, the customer may be given an opportunity to change the preferences to allow the payment processing request to go through. If the payment processing request does meet all of the preferences, at 412, the secure payment system generates an authorization request using the information in the customer account.

As mentioned above preferences provide a large amount of flexibility in how a customer account can be used. For example, preferences can define a hierarchy of payment devices, merchant-specific preferences that apply to particular merchants, distributed payment rules, maximum purchase amount for electronic payment transactions, maximum number of purchase allowed, minimum balances that must be maintained on the customer account, and the like. The secure payment system generates the payment authorization request based on the defined preferences. Thus, depending on which payment devices are specified/allowed, which merchants are authorized to use a particular payment device, and the like, the information contained in a payment authorization request 600 can include various information.

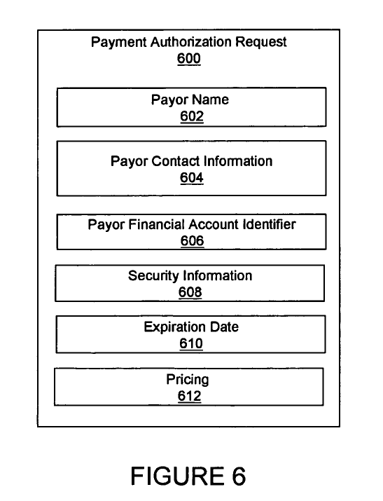

FIG. 6 shows an example of a payment authorization request 600 that can be sent to the payment gateway is generated using the preferences specified in the customer account. This can include payor name 602, payor contact information 604 (such as address, telephone, email, etc.), payor financial account identifier 606 (such as an account number, routing transit number), security information 608 associated with the payment device (such as a PIN verification information), expiration date 610 of the payor financial account, and payment amount 612 (such as purchase price, tax, total purchase amount, etc.). Some or all of this information can come from the customer account and/or the payment processing request. Notably, in one particular embodiment, the sensitive payment data can came from the secure payment system and not the merchant, keeping the merchant shielded from access to this sensitive payment data.

Returning to FIG. 4, at 414, the payment gateway processes the authorization request. The payment gateway accesses various payment systems including, but not limited to, credit card, banking, ACH systems, or proprietary non-settlement payment systems. The selected payment system processes the authorization request. At 416, the payment gateway returns a payment authorization status that can include information on whether the billing information was submitted to one of the payment systems and the status of the payment authorization request (i.e., approved, declined, or process failure). Notably, in embodiment where a merchant specifies only a unique identifier, the merchant is unaware of how the authorization request is actually processed. In other words, the merchant does not know whether payment was made through a customer's credit card, checking account, debit account, or other financial account. The merchant is only aware that the payment was authorized, declined, or whether there was some system failure.

At 418, the secure payment system associates the payment authorization status with the customer account and forwards the payment authorization status to the merchant. At 420, the merchant receives the payment authorization status and can complete its processes to complete the electronic payment transaction. The above process illustrates that where the merchant elects not to include sensitive payment data in the payment processing request, and only includes a unique identifier, the merchant is still able to complete the payment transaction.

The present invention provides a large amount of flexibility in how a merchant can use the system. An embodiment will now be described in which the merchant never receives customer financial information. Following the example methods above, when a customer is online making a purchase at the merchant website, and does not yet have a unique identifier for the secure payment system, when it comes time to collect the customer's financial information, the merchant's website redirects the customer to a website hosted by the secure payment system. The customer initiates generation of a customer account and enters payment device information and any preferences.

The secure payment system generates a unique identifier which is sent back to the customer, and, optionally, can be saved at the merchant website. The merchant website may then either populate the purchase form with the unique identifier for the customer or request that the customer input the unique identifier. After receiving appropriate user input from the customer (e.g., clicking a “submit payment now” button, etc.), the merchant generates a payment processing request identifying the unique identifier and sends the payment processing request to the secure payment system along with the purchase amount for the transaction. The transaction is processed by the secure payment system and payment gateway as already described above. The merchant then receives a notification of whether the payment was approved, denied, or pending for any reason. Advantageously, the merchant does not need to store any sensitive payment device information. Since the customer's financial information has been inputted into the secure payment system and not the merchant's website, this relieves the merchant from having to be PCI-compliant.

In an alternative embodiment, the secure payment system can return a listing of one or more payment devices in a PCI-compliant manner to the merchant website. For example, the secure payment system can return masked credit card or checking account/routing numbers to the merchant website. The merchant can then auto-populate these payment options into the payment interface and allow the customer to select one of them for payment. Of course, the payment devices returned to the merchant will need to comply with any preferences.

The present invention can be used in conjunction with other security methods that are presently known in the art to secure the information between the customer and the secure payment system. Various security methods are known in the art and, thus, to avoid obscuring the present invention, will not be described in detail herein. One example of a security method includes a merchant running Windows CardSpace on their website. When the customer is ready to make a payment, CardSpace locks the display to the CardSpace program which displays any information cards stored on the customer's computer. The secure payment system can configure the unique identifier as a virtual information card, so that it can be displayed in the CardSpace program. The customer can then select the unique identifier information card for payment. CardSpace contacts the secure payment system to verify the customer's identity. The merchant's website can then submit the payment processing request with the unique identifier and purchase amount for processing as described above.

While the unique identifier has been described as being stored at the merchant site or by the customer computer, it will be appreciated that the unique identifier could be stored on a physical card that the customer can carry with him/her. As long as storing the unique identifier in this manner does not violate PCI compliance, this may be another viable method of implementing the present invention.

In yet another embodiment, a preference can be specified to make a unique identifier valid for only a specified number of uses or for a period of time. This allows more than one unique identifier to be associated with a customer account but give flexibility to the customer as to how the customer account can be used. Thus, the method shown in FIG. 2 can be slightly modified to accommodate a temporary unique identifier. For example, at 202, the customer can specify that a temporary unique identifier be generated for the customer account. For example, the customer could select a checkbox or other indicator in user interface which indicates that the customer wishes to make a temporary unique identifier. At 206, the secure payment system generates the temporary unique identifier associated with the customer account that is valid for a maximum number of uses.

To process an electronic payment transaction, the method shown in FIG. 4 can be slightly modified to accommodate a temporary unique identifier. At 406, the merchant uses the temporary unique identifier in the payment processing request. As above, the merchant is not required to specify any particular payment device to be used to process the payment processing request. At 410, the secure payment system evaluates the payment processing request to determine whether the temporary unique identifier is valid. This can include accessing the customer account to determine the maximum number of uses specified for a particular temporary unique identifier, or the period of time for which a temporary unique identifier is valid. Determining whether the temporary unique identifier is valid can include determining whether receipt of the temporary unique identifier is below or meets the maximum number of uses 338 such that the receipt of the temporary unique identifier is valid. Additionally or alternatively, determining whether the temporary unique identifier is valid comprises determining whether the temporary unique identifier has been received within the specified period of time 340 such that the receipt of the temporary unique identifier is valid.

If the temporary identifier is valid, the secure payment system proceeds to process the payment processing request according to any other preferences, such as specific payment devices that can be used, preferences particular to a particular merchant, distributed payment rules, maximum purchase amounts, minimum balances, and the like. If preferences are satisfied, the secure payment system sends an authorization request to the payment gateway as described above.

The following illustrates how various preferences can be as complex as needed to provide a customer with the ability to carry on its business without complications. For example, a customer may be a distributor in a multi-level marketing organization. The customer can specify a payment schedule 344 to “autoship” an order the same day of the month and to make payment the same day of the month. The secure payment system can thus generate a temporary unique identifier before each autoship, and specify the amount for which the unique identifier is valid or place other restrictions on the unique identifier. This is one example of a general ability of the present invention to provide multiple payment options so that merchants have a greater certainty of getting paid.

The advantages of the present invention can also be readily seen in other areas, such as for nutritional products, which need to be shipped within a certain time frame, but where the customer also does not want to run out of product. If the customer wants a shipment on a certain date, the merchant wants to make sure that they are going to get paid for the product. By having multiple payment options, the present invention lessens the likelihood that the merchant isn't going to run into a disapproval or decline of a card, and then either delay the shipment or have to track down that customer for payment. Similar benefits could apply to all types of industries that require financial payment, or those which require recurring transactions, such as health club memberships, property management (storage facilities, homeowner association dues), and the like.

Embodiments include general-purpose and/or special-purpose devices or systems that include both hardware and/or software components. Embodiments may also include physical computer-readable media and/or intangible computer-readable media for carrying or having computer-executable instructions, data structures, and/or data signals stored thereon. Such physical computer-readable media and/or intangible computer-readable media can be any available media that can be accessed by a general purpose or special purpose computer. By way of example, and not limitation, such physical computer-readable media can include RAM, ROM, EEPROM, CD-ROM or other optical disk storage, magnetic disk storage or other magnetic storage devices, other semiconductor storage media, or any other physical medium which can be used to store desired data in the form of computer-executable instructions, data structures and/or data signals, and which can be accessed by a general purpose or special purpose computer. Within a general purpose or special purpose computer, intangible computer-readable media can include electromagnetic means for conveying a data signal from one part of the computer to another, such as through circuitry residing in the computer.

When information is transferred or provided over a network or another communications connection (either hardwired, wireless, or a combination of hardwired or wireless) to a computer, hardwired devices for sending and receiving computer-executable instructions, data structures, and/or data signals (e.g., wires, cables, optical fibers, electronic circuitry, chemical, and the like) should properly be viewed as physical computer-readable mediums while wireless carriers or wireless mediums for sending and/or receiving computer-executable instructions, data structures, and/or data signals (e.g., radio communications, satellite communications, infrared communications, and the like) should properly be viewed as intangible computer-readable mediums. Combinations of the above should also be included within the scope of computer-readable media.

Computer-executable instructions include, for example, instructions, data, and/or data signals which cause a general purpose computer, special purpose computer, or special purpose processing device to perform a certain function or group of functions. Although not required, aspects of the invention have been described herein in the general context of computer-executable instructions, such as program modules, being executed by computers, in network environments and/or non-network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

Embodiments may also include computer program products for use in the systems of the present invention, the computer program product having a physical computer-readable medium having computer readable program code stored thereon, the computer readable program code comprising computer executable instructions that, when executed by a processor, cause the system to perform the methods of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of processing electronic payment transactions using at least one payment device of a customer without requiring a merchant to store data specific to the at least one payment device, the method comprising:
receiving identification information of a customer account;
generating a unique identifier associated with the customer account;
receiving data specific to a first payment device;
storing identification information of the customer account and the data specific to the first payment device;
providing the unique identifier to at least one of the merchant or a customer;
receiving a payment processing request from the merchant that includes the unique identifier; and
processing the payment processing request using the first payment device such that the merchant is only required to identify the unique identifier of the customer account and not the data specific to the first payment device.

2. The method as recited in claim 1, further comprising receiving one or more preferences associated with the unique identifier.

3. The method as recited in claim 2, further comprising receiving data specific to a second payment device, wherein receiving one or more preferences associated with the unique identifier comprises receiving at least one of:
an order in which the first payment device and second payment device should be used to process a payment processing request from a merchant;
a preference that payment processing requests from a particular merchant can only be processed using one of the first payment device or the second payment device, but not both; or
distributed payment rules between the first payment device and the second payment device.

4. The method as recited in claim 2, wherein the one or more preferences comprises at least one of:
a particular merchant authorized to make payment processing requests using the unique identifier;
a maximum purchase amount allowed for a payment processing request associated with the unique identifier;
a maximum number of uses allowed for the unique identifier;
a maximum time period allowed for the unique identifier;
a minimum balance that must be maintained on the first payment device before a payment processing request is allowed; or
a payment schedule.

5. The method as recited in claim 1, wherein receiving identification information of a customer account and receiving data specific to a first payment device occur from a merchant independent of when a customer is attempting an electronic payment transactions.

6. The method as recited in claim 1, wherein receiving identification information of a customer account and receiving data specific to a first payment device occurs while the customer is attempting an electronic payment transaction.

7. A method of processing electronic payment transactions using at least one payment device of a customer without requiring a merchant to store data specific to the at least one payment device, the method comprising:
receiving identification information of a customer account;
generating a unique identifier associated with the customer account;
receiving data specific to a first payment device and a second payment device;
receiving one or more preferences associated with the unique identifier including receiving an order in which the first payment device and second payment device should be used to process a payment processing request from a merchant;
storing identification information of the customer account, the data specific to the first payment device and second payment device, and the one or more preferences associated with the customer account;
providing the unique identifier to at least one of a merchant or a customer;
receiving a payment processing request from a merchant that includes the unique identifier but does not specify which of the first payment device or second payment device to use to process the payment processing request; and
processing the payment processing request according to the one or more preferences such that the merchant is only required to specify the unique identifier of the customer account and not the data specific to the first payment device or second payment device.

8. The method as recited in claim 7, wherein receiving one or more preferences associated with the unique identifier comprises receiving a preference that payment processing requests from a particular merchant can only be processed using one of the first payment device or the second payment device, but not both.

9. The method as recited in claim 7, wherein receiving one or more preferences associated with the unique identifier comprises receiving a preference that payment processing requests should be processed by distributing payment between the first payment device and the second payment device.

10. A method of processing electronic payment transactions using at least one payment device of a customer without requiring a merchant to store data specific to the at least one payment device, the method comprising:
receiving identification information of a customer account;
generating a unique identifier associated with the customer account;
receiving data specific to a first payment device and a second payment device;
receiving one or more preferences associated with the unique identifier including receiving a preference that payment processing requests from a merchant can only be processed using one of the first payment device or the second payment device, but not both;
storing identification information of the customer account, the data specific to the first payment device and second payment device, and the one or more preferences associated with the customer account;
providing the unique identifier to at least one of the merchant or a customer;
receiving a payment processing request from the merchant that includes the unique identifier; and
processing the payment processing request according to the one or more preferences such that the merchant is only required to identify the unique identifier of the customer account and not the data specific to the first payment device or second payment device.

11. The method as recited in claim 10, wherein the payment processing request does not specify which of the first payment device or second payment device to use to process the payment processing request.

12. The method as recited in claim 10, wherein the payment processing request does specify which of the first payment device or second payment device to use to process the payment processing request.

13. The method as recited in claim 10, further comprising
receiving data specific to a third payment device;
receiving a preference that payment processing requests from the merchant can also be processed using the third payment device; and
receiving a preference of an order in which the first payment device, second payment device and third payment device should be used to process a payment processing request from any merchant.

14. The method as recited in claim 13, wherein receiving one or more preferences associated with the unique identifier comprises receiving a preference that payment processing requests for the merchant should be processed by distributing payment between the first payment device and the third payment device.

15. A method of processing electronic payment transactions using at least one payment device of a customer without requiring a merchant to store data specific to the at least one payment device, the method comprising:
receiving identification information of a customer account;
generating a unique identifier associated with the customer account;
receiving data specific to a first payment device and a second payment device;
receiving one or more preferences associated with the unique identifier including receiving distributed payment rules to distribute a payment processing request from a merchant between the first payment device and second payment device;
storing identification information of the customer account, the data specific to the first payment device and second payment device, and the one or more preferences associated with the customer account;
providing the unique identifier to at least one of a merchant or a customer;
receiving a payment processing request from a merchant that includes the unique identifier but does not specify which of the first payment device or second payment device to use to process the payment processing request; and
processing the payment processing request according to the one or more preferences such that the merchant is only required to specify the unique identifier of the customer account and not the data specific to the first payment device or second payment device.

16. The method as recited in claim 15, wherein the distributed payment rules define a ratio that defines a percentage of a total purchase amount to be paid using the first payment device, and a percentage of the total purchase amount to be paid using the second payment device.

17. The method as recited in claim 15, wherein the distributed payment rules define a first tier that defines an amount up to which to use the first payment device to pay at least a portion of a total purchase amount and a second tier that defines an amount above the first tier amount up to which to use the second payment device to pay at least a portion of a total purchase amount.

18. A method of processing electronic payment transactions using at least one payment device of a customer without allowing a merchant to store payment device-specific data, the method comprising:
receiving identification information of a customer account;
receiving a request for a temporary unique identifier associated with the customer account;
generating the temporary unique identifier associated with the customer account that is valid for a maximum number of uses;
receiving data specific to a first payment device;
storing identification information of the customer account, the data specific to the first payment device, and the one or more preferences associated with the customer account;
providing the temporary unique identifier to at least one of a merchant or a customer;
receiving payment processing request from a merchant that does not specify which of the first payment device or second payment device to be used to process the payment processing request, the payment processing request including the temporary unique identifier;
determining whether the temporary unique identifier is valid; and
if the temporary identifier is valid, processing the payment processing request according to the one or more preferences such that the merchant is only required to identify the temporary unique identifier of the customer account and not the data specific to the first payment device or second payment device.

19. The method as recited in claim 18, wherein generating the temporary unique identifier associated with the customer account that is valid for a maximum number of uses also includes defining a specified period of time for which the temporary unique identifier is valid.

20. The method as recited in claim 18, wherein determining whether the temporary unique identifier is valid comprises determining whether receipt of the temporary unique identifier is below or meets the maximum number of uses such that the receipt of the temporary unique identifier is valid.

21. The method as recited in claim 19, wherein determining whether the temporary unique identifier is valid comprises determining whether the temporary unique identifier has been received within the specified period of time such that the receipt of the temporary unique identifier is valid.
